(19) United States
(12) Patent Application Publication
(10) Pub. No.: US 2019/0160416 A1
(43) Pub. Date: May 30, 2019

(54) AIR PURIFICATION DEVICE FOR VEHICLE

(71) Applicant: HONDA MOTOR CO., LTD., Tokyo (JP)

(72) Inventors: Subaru MATSUMOTO, Wako-shi (JP); Shinji KAKIZAKI, Wako-shi (JP)

(21) Appl. No.: 16/183,173

(22) Filed: Nov. 7, 2018

(30) Foreign Application Priority Data
Nov. 30, 2017 (JP) 2017230693

(51) Int. Cl. B01D 53/04; B60H 3/00

(52) U.S. Cl. CPC B01D 53/0446; B01D 2259/4566; B01D 2257/504; B60H 3/0085

(57) ABSTRACT

An air purification device for a vehicle, includes: an air intake duct having a suction opening for sucking air in a vehicle cabin; a carbon dioxide removal device that has an inlet connected to the air intake duct and sorbs and removes carbon dioxide contained in air supplied through the inlet; an air supply duct connected to a first outlet of the carbon dioxide removal device and having a blowing opening for blowing purified air from which carbon dioxide has been removed by the carbon dioxide removal device into the vehicle cabin; and an exhaust duct connected to a second outlet of the carbon dioxide removal device and having an exhaust opening for discharging the carbon dioxide sorbed by the carbon dioxide removal device to outside of the vehicle cabin, wherein the suction opening is provided at a position lower than the blowing opening.

### TECHNICAL FIELD

The present disclosure relates to an air purification device for a vehicle provided with a carbon dioxide removal device for removing carbon dioxide from air.

### BACKGROUND ART

WO2009/063848A discloses a ventilating apparatus for a vehicle, which is provided with a temperature detector for detecting a temperature in a passenger compartment, such that when the temperature in the passenger compartment exceeds a specified value in a state where there is no occupant in the passenger compartment, the fan is operated so that the air in the passenger compartment is discharged to the outside of the vehicle. This ventilating apparatus further includes a carbon dioxide concentration sensor disposed underneath a front seat to detect the carbon dioxide concentration in the passenger compartment when the ignition switch is on, such that when the detected carbon dioxide concentration in the passenger compartment exceeds a prescribed reference value, the fan is operated to cause the air in the passenger compartment to be drawn into the exhaust duct from the inlet opening, which faces forward underneath the rear seat, and the air drawn into the exhaust duct is exhausted to the outside of the vehicle via a trunk compartment.

JP2005-306271A discloses an oxygen enrichment device for supplying oxygen enriched air to a vehicle occupant. This oxygen enrichment device includes a main body formed with an air inlet and disposed at the back of the seat or under the seat, and a pair of blower ducts extending from the main body along the back of the seat to have blowing openings located on respective sides of the headrest and facing obliquely forward such that the air flows from the blowing openings meet in front of the face of the occupant to form an oxygen enriched area around the face, whereby oxygen enriched air with an appropriate concentration is supplied to around the face of the occupant without the air discharged from the nozzles directly impinging upon the nose and mouth of the occupant.

Typically, an air conditioner for an automobile has an outside air introduction mode for admitting outside air into the passenger compartment and an inside air recirculation mode for recirculating the air in the passenger compartment. In the outside air introduction mode, fresh air can be introduced into the passenger compartment, but the temperature-controlled air in the passenger compartment is discharged to the outside of the vehicle, which results in a large loss of thermal energy due to ventilation (ventilation loss). Conversely, in the inside air recirculation mode, because the temperature-controlled air in the passenger compartment is recirculated, the ventilation loss is prevented, but the air in the passenger compartment may have a high carbon dioxide concentration and humidity.

In the ventilating apparatus for a vehicle disclosed in WO2009/063848A, the air in the passenger compartment is discharged to the outside as it is, and outside air is introduced into the passenger compartment along with this. Therefore, when the temperature of the air in the passenger compartment is controlled by the air conditioner, heat of the temperature-controlled air is released to the outside, resulting in a large ventilation loss.

On the other hand, in the oxygen enrichment device disclosed in JP2005-306271A, though the oxygen-enriched air is blown from the blowing openings toward an area in front of the face of the occupant, carbon dioxide is not discharged to the outside of the vehicle. Therefore, when the air conditioner is in the inside air recirculation mode or is not in operation, the carbon dioxide concentration in the passenger compartment increases after a long driving. As a result, even though the oxygen enriched air generated by the oxygen enrichment device is mixed in the air in the passenger compartment, the carbon dioxide concentration can still be high, making it difficult to prevent the driver's concentration drop, drowsiness, and fatigue. Further, because the blower ducts are fixed along the back of the seat (seat back), the blower ducts can be a nuisance to an occupant in the rear seat. If the blower ducts are routed in the seat back to avoid being a nuisance, it may cause an increase in the lateral size of the seat back and/or a reduction in the cushioning performance of the seat back.

### SUMMARY OF THE INVENTION

In view of such background, a primary object of the present invention is to provide an air purification device for a vehicle that can prevent an increase in the carbon dioxide concentration in the passenger compartment (vehicle cabin) for an extended period of time while suppressing the ventilation loss even when the air conditioner is in the inside air recirculation mode or not in operation.

To achieve the above object, one embodiment of the present invention provides an air purification device (10) for a vehicle (1), comprising: an air intake duct (16) having one end formed with a suction opening (16a) for sucking air in a vehicle cabin (3); a carbon dioxide removal device (12) that has an inlet (12a) connected to another end of the air intake duct and sorbs and removes carbon dioxide contained in air supplied through the inlet; an air supply duct (17) having one end connected to a first outlet (12b) of the carbon dioxide removal device and another end formed with a blowing opening (17a) for blowing purified air from which carbon dioxide has been removed by the carbon dioxide removal device into the vehicle cabin; and an exhaust duct (18) having one end connected to a second outlet (12c) of the carbon dioxide removal device and another end formed with an exhaust opening (18a) for discharging the carbon dioxide sorbed by the carbon dioxide removal device to outside of the vehicle cabin, wherein the suction opening (16a) is provided at a position lower than the blowing opening (17a).

According to this arrangement, air in the vehicle cabin is sucked through the suction opening of the air intake duct into the carbon dioxide removal device, where carbon dioxide is removed from the air, and the purified air is blown from the blowing opening of the air supply duct into the vehicle cabin. The carbon dioxide sorbed (namely, adsorbed and/or absorbed) by the carbon dioxide removal device is discharged from the exhaust opening of the exhaust duct to the outside of the vehicle cabin. Therefore, even when the air conditioner is in the inside air recirculation mode or not in operation, it is possible to prevent an increase in the carbon dioxide concentration in the vehicle cabin for an extended period of time, and to suppress the ventilation loss. Further, because the suction opening is provided at a position lower than the blowing opening, the air purification device can suck part of the air in the vehicle cabin having a high carbon dioxide concentration, and supply purified air from which carbon dioxide has been removed to around the face of a vehicle occupant.

In the above arrangement, preferably, the blowing opening (17a) is provided in a roof (22) or an upper part of a pillar (21, 24) of a vehicle body (4).

According to this arrangement, there is no need to arrange the air supply duct along the seat back of a front seat, and therefore, the air supply duct is prevented from being a nuisance to an occupant in a rear seat, and an increase in size of the seat back and a reduction in the cushioning performance of the same are avoided. Namely, it is possible to supply purified air to around the face of the driver without an adverse influence on the comfort of the vehicle occupants.

In the above arrangement, preferably, the suction opening (16a) is provided at a foot of a rear seat (6).

According to this arrangement, air having a high carbon dioxide concentration is sucked through the suction opening provided in a lower part of the vehicle cabin, and hence, carbon dioxide can be removed efficiently.

In the above arrangement, preferably, the carbon dioxide removal device (12) is integrally mounted to a rear seat (6).

According to this arrangement, the carbon dioxide removal device can be installed in the vehicle body by installing the rear seat integrally provided with the carbon dioxide removal device in the vehicle body. Therefore, the number of steps for installing component parts in the vehicle can be reduced.

Thus, according to an embodiment of the present invention, it is possible to provide an air purification device for a vehicle that can prevent an increase in the carbon dioxide concentration in the vehicle cabin for an extended period of time while suppressing the ventilation loss even when the air conditioner is in the inside air recirculation mode or not in operation.

### BRIEF DESCRIPTION OF THE DRAWINGS

FIG. 1 is a side view of an automobile comprising an air purification device according to an embodiment of the present invention;

FIG. 2 is a perspective view of the automobile shown in FIG. 1; and

FIG. 3 is a perspective view of the air purification device shown in FIG. 1.

### DESCRIPTION OF THE PREFERRED EMBODIMENT(S)

In the following, preferred embodiments of the present invention will be described in detail with reference to the drawings.

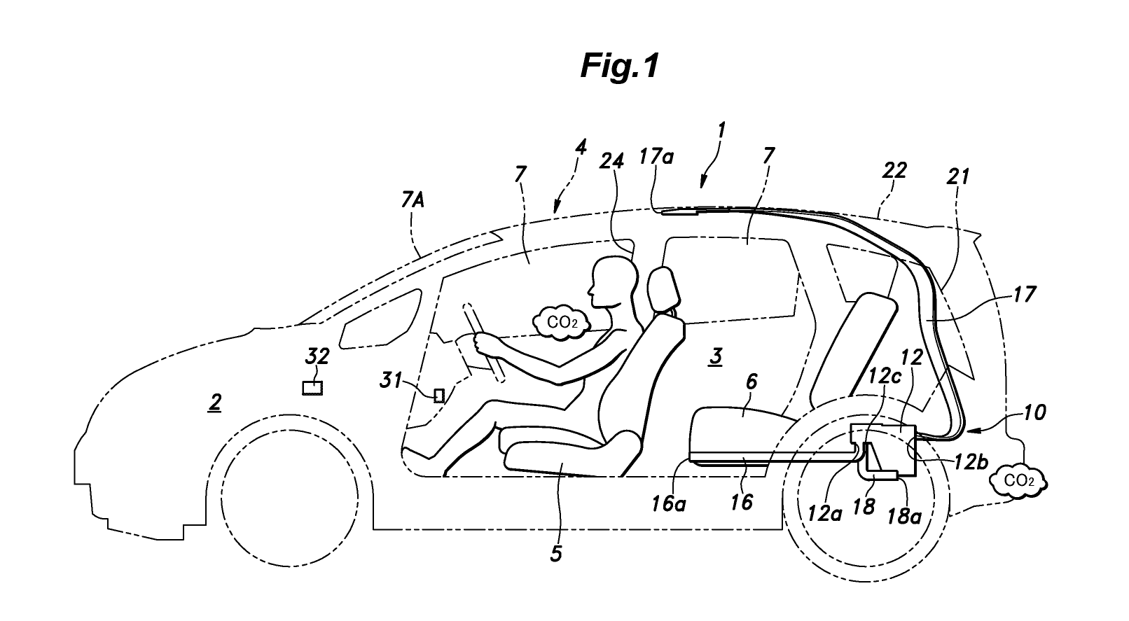

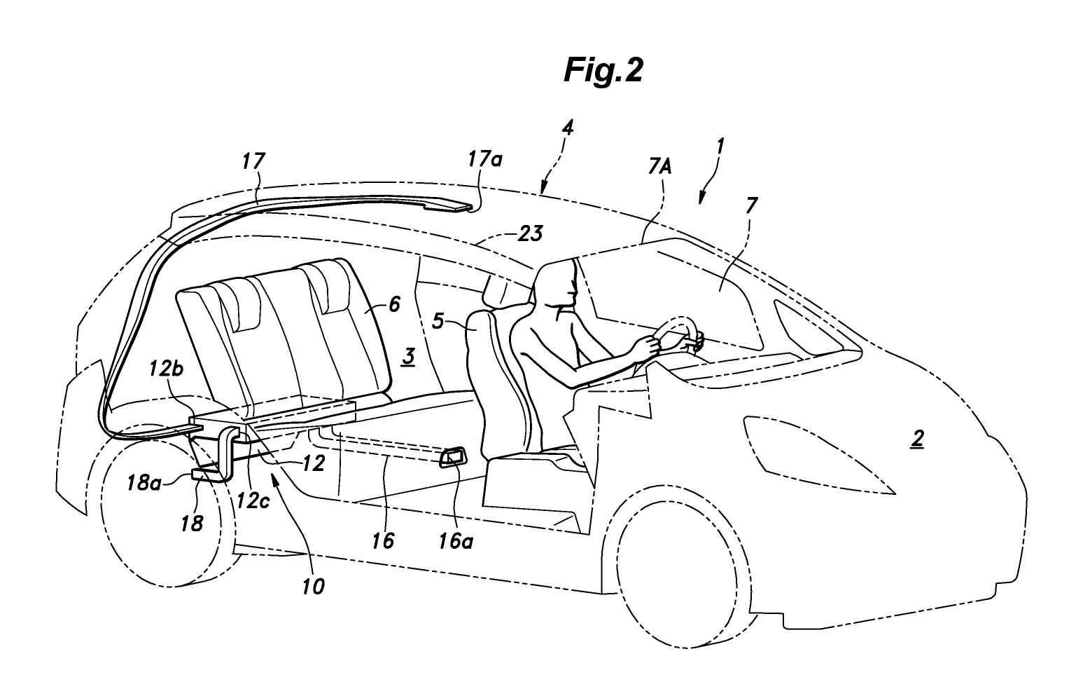

As shown in FIGS. 1 and 2, an automobile 1 includes a vehicle body 4 having an engine room 2 defined in a front part thereof and a vehicle cabin 3 defined behind the engine room 2. It is to be noted that when the automobile 1 is an electric car, the engine room 2 typically contains an electric motor, a power control unit for controlling the electric motor, a heat exchanger (radiator) for cooling the power control unit, etc. In a case where a plurality of electric motors are used to individually drive the wheels of the automobile 1, the electric motors may be disposed near the respective wheels outside the engine room 2.

The vehicle cabin 3 includes a passenger compartment where the driver and passengers are to be seated and a cargo space arranged behind the passenger compartment to be in communication with the passenger compartment. In the vehicle cabin 3, a pair of front seats (one of which is a driver's seat) 5 and a two or three-seater rear seat 6 are arranged in a fore and aft direction in two rows. An upper part of the vehicle body 4 is provided with a plurality of glass windows 7 including a windshield 7A. Further, the automobile 1 is equipped with an air purification device 10 for purifying the air in the vehicle cabin 3.

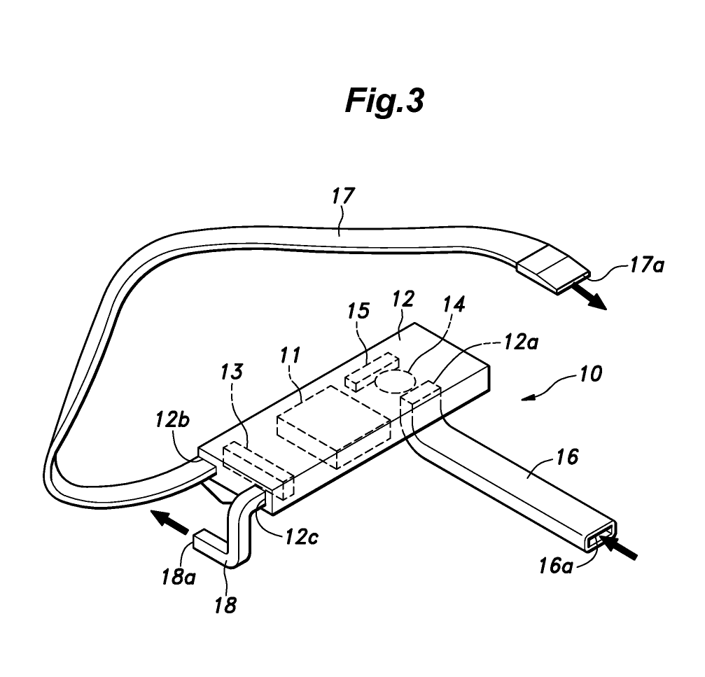

The air purification device 10 includes a carbon dioxide removal device 12 provided with an adsorbent (or absorbent) 11 (see FIG. 3) that, at a purification temperature, adsorbs (or absorbs) carbon dioxide in the air, and at a regeneration temperature higher than the purification temperature, releases (or desorbs) the adsorbed (or absorbed) carbon dioxide. In the present embodiment, the carbon dioxide removal device 12 is integrally mounted to the rear seat 6. The position where the carbon dioxide removal device 12 may be provided is not limited to this, and may be in the cargo space, below the cargo space, or in the engine room 2, for example.

The adsorbent 11 in the present embodiment consists of synthetic zeolite, which adsorbs carbon dioxide at a normal temperature (e.g., 0 to 30 degrees Celsius), and releases the adsorbed carbon dioxide at a regeneration temperature (e.g., 40 degrees Celsius) higher than the normal temperature. In the present description, the temperature at which the adsorbent 11 adsorbs carbon dioxide is referred to as a purification temperature. It is to be noted that the adsorbent (or absorbent) 11 that can be used in the present embodiment is not limited to synthetic zeolite, and may be any adsorbent or absorbent (summarily referred to as sorbent) having a property of releasing adsorbed (or absorbed) carbon dioxide at a temperature higher than the purification temperature, and may be liquid or solid. Examples that can be used as the adsorbent 11 (or absorbent) include activated carbon, zeolite, silica sand (silicon), barium orthotitanate, porous cerium oxide, polyamine, potassium carbonate, amine solution, amide-imide solution, alcohol solution, ether solution, ketone solution, carbonate solution, lactone solution, hydrocarbon solution, etc.

Synthetic zeolite, which is used as the adsorbent 11 in the present embodiment, has a property of adsorbing moisture (namely, water in the form of vapor (gas) or liquid) in the air at the purification temperature, and releasing the adsorbed moisture at the regeneration temperature. Namely, the adsorbent 11 adsorbs carbon dioxide and moisture simultaneously at the purification temperature, and releases carbon dioxide and moisture simultaneously at the regeneration temperature. Thus, the carbon dioxide removal device 12 serves as a carbon dioxide and moisture removal device.

With additional reference to FIG. 3, the carbon dioxide removal device 12 is provided with an inlet 12a for admitting air therein, and a first outlet 12b and a second outlet 12c for discharging air therefrom. Further, the carbon dioxide removal device 12 has a built-in three-way valve 13 (flow path switching damper) for selectively closing one of the first outlet 12b and the second outlet 12c, such that the air entering through the inlet 12a is discharged from the first outlet 12b or the second outlet 12c after flowing through the interior of the carbon dioxide removal device 12. The adsorbent 11 for adsorbing carbon dioxide in the air is provided in the form of a filter in a part of the carbon dioxide removal device 12 through which the air flows.

In a part of the carbon dioxide removal device 12 on a side of the inlet 12a with respect to the adsorbent 11, a blower 14 for sending air from the inlet 12a toward the first outlet 12b or the second outlet 12c and a heater 15 for heating the air are provided.

An air intake duct 16 is connected to the inlet 12a of the carbon dioxide removal device 12. The air intake duct 16 has one end formed with a suction opening 16a for sucking air in the vehicle cabin 3, and another end connected to the inlet 12a of the carbon dioxide removal device 12.

The air purification device 10 further includes an air supply duct 17 having one end connected to the first outlet 12b of the carbon dioxide removal device 12, and an exhaust duct 18 having one end connected to the second outlet 12c of the same. The other end of the air supply duct 17 is formed with a blowing opening 17a from which air is blown into the vehicle cabin 3, and the other end of the exhaust duct 18 is formed with an exhaust opening 18a from which air is discharged to the outside of the vehicle cabin 3.

As shown in FIGS. 1 and 2, the air intake duct 16 extends forward from the inlet 12a of the carbon dioxide removal device 12 to pass under the rear seat 6, such that the suction opening 16a faces forward at the foot of the rear seat 6, namely, in a lower part of the vehicle cabin 3. Though not shown in the drawings, the suction opening 16a is provided with a filter for preventing intrusion of dust.

When the air volume of an air conditioner for controlling the temperature in the vehicle cabin 3 is small, carbon dioxide, which is denser than air, tends to accumulate in a lower part of the vehicle cabin 3. Thus, with the suction opening 16a being located in a lower part of the vehicle cabin 3 as described above, the air intake duct 16 can suck part of the air in the vehicle cabin 3 having a high concentration of carbon dioxide. Also, when the air conditioner is in heating operation, the user (vehicle occupant) often selects a heat mode (HEAT) in which warmed air is blown toward the feet of the user or a heat/defog mode (H/D) in which warmed air is blown toward the feet of the user and toward the windshield. In such cases, air in the vehicle cabin 3 tends to stagnate, and air having a high carbon dioxide concentration tends to accumulate and form a layer in a lower part of the vehicle cabin 3 (concentration stratification tends to occur). As described above, because the suction opening 16a is provided at the foot of the rear seat 6 where carbon dioxide in the vehicle cabin 3 is most likely to accumulate, the air intake duct 16 can suck part of the air in the vehicle cabin 3 having the highest carbon dioxide concentration.

The air supply duct 17 extends from the first outlet 12b through the interior of parts of the vehicle body 4 to an upper part of the vehicle body 4, where the blowing opening 17a opens to the vehicle cabin 3. Specifically, the air supply duct 17 extends upward between an outer panel member and an upholstery member of a right rear pillar 21 and then extends forward along a roof side rail 23 on a right edge of a roof 22, such that at a part of the roof 22 where a center pillar 24 is joined, the blowing opening 17a opens obliquely downward toward the front and left direction, such that air blown from the blowing opening 17a is directed to the driver seated in the driver's seat (it is assumed here that the driver's seat is the right one of the pair of front seats 5).

The exhaust duct 18 extends downward from the second outlet 12c to pass through the vehicle body 4 and then is bent rearward, such that the exhaust opening 18a opens rearward under the vehicle body 4.

The automobile 1 is provided in an appropriate part thereof with an in-cabin CO2 sensor 31 (FIG. 1) that detects the carbon dioxide concentration in the vehicle cabin 3. Further, the automobile 1 is provided with a controller 32 (FIG. 1) for controlling an operation of the carbon dioxide removal device 12 by drive-controlling the three-way valve 13, the blower 14, and the heater 15 in accordance with an output of the in-cabin CO2 sensor 31.

When the carbon dioxide concentration in the vehicle cabin 3 detected by the in-cabin CO2 sensor 31 reaches a predetermined value, the controller 32 controls the carbon dioxide removal device 12 in a purification mode, in which air in the vehicle cabin 3 is sent into the carbon dioxide removal device 12 at the purification temperature, and the purified air from which moisture and carbon dioxide have been removed by the adsorbent 11 is blown into the vehicle cabin 3. Specifically, when executing the purification mode, the controller 32 controls the three-way valve 13 to close the exhaust duct 18 and open the air supply duct 17, and drives the blower 14 without driving the heater 15.

Further, the controller 32 estimates a state of adsorption of carbon dioxide by the adsorbent 11 based on the detection value of the in-cabin CO2 sensor 31 and the operating time of the carbon dioxide removal device 12 in the purification mode. It is to be noted here that the carbon dioxide adsorption state can be represented by a ratio of an amount of CO2 currently adsorbed (or held) by the adsorbent 11 to the maximum amount of CO2 that can be adsorbed by the adsorbent 11. When the estimated carbon dioxide adsorption state reaches a predetermined threshold value (e.g., 95%), the controller 32 controls the carbon dioxide removal device 12 in a regeneration mode, in which air heated to the regeneration temperature is sent into the carbon dioxide removal device 12, and exhaust air containing carbon dioxide released from the adsorbent 11 is discharged to the outside of the vehicle cabin 3. Specifically, when executing the regeneration mode, the controller 32 controls the three-way valve 13 to close the air supply duct 17 and open the exhaust duct 18, and drives the heater 15 and the blower 14 such that the temperature of the air sent to the adsorbent 11 is raised to the regeneration temperature (e.g., 40 degrees Celsius).

As described above, in the purification mode, air in the vehicle cabin 3 is sucked through the suction opening 16a of the air intake duct 16 into the carbon dioxide removal device 12, where carbon dioxide is removed from the air, and the purified air is blown from the blowing opening 17a of the air supply duct 17 into the vehicle cabin 3. In the regeneration mode, the carbon dioxide adsorbed by the carbon dioxide removal device 12 is discharged from the exhaust opening 18a of the exhaust duct 18 to the outside of the vehicle cabin 3. Therefore, even when the air conditioner is in the inside air recirculation mode or not in operation, it is possible to prevent an increase in the carbon dioxide concentration in the vehicle cabin 3 for an extended period of time. In addition, because in the purification mode the air in the vehicle cabin 3 is not discharged to the outside of the vehicle cabin 3, the ventilation loss can be suppressed.

Further, because the suction opening 16a is provided at a position lower than the blowing opening 17a, part of the air in the vehicle cabin 3 having a high carbon dioxide concentration is sucked into the air purification device 10, and the purified air from which carbon dioxide has been removed is supplied by the air purification device 10 to around the face of the vehicle occupant.

In the present embodiment, the blowing opening 17a is provided in the roof 22 of the vehicle body 4, and there is no need to arrange the air supply duct 17 along the seat back of the front seat (driver's seat) 5. Therefore, the air supply duct 17 is prevented from being a nuisance to an occupant in the rear seat 6, and an increase in size of the seat back of the front seat 5 and a reduction in the cushioning performance of the same are avoided. Namely, it is possible to supply purified air to around the face of the driver without an adverse influence on the comfort of the vehicle occupants.

In addition, in the present embodiment, because the suction opening 16a is provided at the foot of the rear seat 6, air having a high carbon dioxide concentration is sucked through the suction opening 16a provided in a lower part of the vehicle cabin 3, and hence, carbon dioxide can be removed efficiently.

Further, because the carbon dioxide removal device 12 is integrally mounted to the rear seat 6 as described above, the carbon dioxide removal device 12 can be installed in the vehicle body 4 by installing the rear seat 6 integrally provided with the carbon dioxide removal device 12 in the vehicle body 4. Therefore, the number of steps for installing component parts in the automobile 1 can be reduced.

The concrete embodiment of the present invention has been described in the foregoing, but the present invention is not limited to the embodiment and may be modified in various ways.

For example, in the above embodiment, the air purification device 10 was installed in the hatchback-type automobile 1 in which a rear part of the vehicle cabin 3 forms a cargo space, but the air purification device 10 may be installed in a sedan-type or coupe type automobile having a cargo room separate from the vehicle cabin 3 (namely, the vehicle cabin 3 consists of a passenger compartment).

Further, though in the above embodiment the blowing opening 17a of the air supply duct 17 is provided in the roof 22 of the vehicle body 4, the blowing opening 17a may be provided in an upper part of the rear pillar 21 or the center pillar 24. In such arrangements also, it is possible to supply purified air to around the face of the driver without an adverse influence on the comfort of vehicle occupants.

In addition, though in the above embodiment the controller 32 drives only the blower 14 without driving the heater 15 when controlling the carbon dioxide removal device 12 in the purification mode, the controller 32 may drive the heater 15 together with the blower 14 to heat air to be purified to a temperate appropriate for the adsorbent 11 to adsorb carbon dioxide.

In the above embodiment, the adsorbent 11 adsorbs carbon dioxide and moisture simultaneously and releases them simultaneously, but in another embodiment, the adsorbent 11 may adsorb only carbon dioxide, and an additional adsorbent for adsorbing moisture may be prepared separately from the adsorbent for adsorbing carbon dioxide. Further, the adsorption temperature for carbon dioxide and the adsorption temperature for moisture may differ from each other, and the release temperature for carbon dioxide and the release temperature for moisture may differ from each other.

The concrete structure, arrangement, number, material, etc. of the component parts of the embodiment may be appropriately changed within the scope of the present invention. Also, not all of the component parts shown in the foregoing embodiment are necessarily indispensable, and they may be selectively used as appropriate.

1. An air purification device for a vehicle, comprising:
an air intake duct having one end formed with a suction opening for sucking air in a vehicle cabin;
a carbon dioxide removal device that has an inlet connected to another end of the air intake duct and sorbs and removes carbon dioxide contained in air supplied through the inlet;
an air supply duct having one end connected to a first outlet of the carbon dioxide removal device and another end formed with a blowing opening for blowing purified air from which carbon dioxide has been removed by the carbon dioxide removal device into the vehicle cabin; and
an exhaust duct having one end connected to a second outlet of the carbon dioxide removal device and another end formed with an exhaust opening for discharging the carbon dioxide sorbed by the carbon dioxide removal device to outside of the vehicle cabin,
wherein the suction opening is provided at a position lower than the blowing opening.

2. The air purification device for a vehicle as defined in claim 1, wherein the blowing opening is provided in a roof or an upper part of a pillar of a vehicle body.

3. The air purification device for a vehicle as defined in claim 1, wherein the suction opening is provided at a foot of a rear seat.

4. The air purification device for a vehicle as defined in claim 1, wherein the carbon dioxide removal device is integrally mounted to a rear seat.
